(19) United States
(12) Patent Application Publication
(10) Pub. No.: US 2026/0150111 A1
(43) Pub. Date: May 28, 2026

(54) METHOD AND NETWORK NODE FOR HANDLING TRANSMISSION ON A PHYSICAL DOWNLINK CONTROL CHANNEL

(71) Applicant: Telefonaktiebolaget LM Ericsson (publ), Stockholm (SE)

(72) Inventors: Kristofer SANDLUND, Lulea (SE); Jonas FRÖBERG OLSSON, Ljungsbro (SE); Jonas PETTERSSON, Lulea (SE); Kristina HESSLER, Linkoping (SE)

(21) Appl. No.: 19/122,216

(22) PCT Filed: Oct. 18, 2022
(86) PCT No.: PCT/SE2022/050940

§ 371 Date: Apr. 17, 2025

(51) Int. Cl. H04W 72/232; H04W 36/00

(52) U.S. Cl. CPC H04W 72/232; H04W 36/00692

(57) ABSTRACT

Disclosed is a method performed by a network node (130) of a wireless communication network (100) for handling transmission on a PDCCH to a UE (140). The method comprises transmitting, to the UE (140), a first DCI in the PDCCH using a first CCE aggregation level, and a second DCI using a second CCE aggregation level, the first and the second DCI respectively instructing 2024/085789 the UE (140) to send a transmission to the network node (130) on a first and a second uplink resource indicated by the first DCI and the second DCI, respectively. The method further comprises determining whether any transmission was received from the UE (140) on the first uplink resource and on the second uplink resource. Then determining, based on the determining whether any transmission was received from the UE (140) on the first uplink resource and on the second uplink resource, which of the first and the second CCE aggregation level to use for a later PDCCH transmission.

### TECHNICAL FIELD

The present disclosure relates generally to methods and network nodes for handling transmission on a Physical Downlink Control Channel (PDCCH) on a Control Resource Set (CORESET) to a User Equipment (UE). The present disclosure further relates to computer programs and carriers corresponding to the above methods and nodes.

### BACKGROUND

In wireless communication networks, wireless communication resources for communication between a network node, aka base station, and a User Equipment (UE), aka wireless device, are a limited resource. Therefore, the communication resources need to be used efficiently. This is important for transmission of control information as well as for transmission of traffic data. Control information is sent over control channels. A Physical Downlink Control Channel (PDCCH) is used for downlink (DL) communication of control information, that is from the network node to the UE.

In Long Term Evolution (LTE), the communication resources are defined as resource elements (RE), which is a unit made up of 1 symbol * 1 subcarrier. A Resource Element Group (REG) is a group of 4 consecutive REs. A Control Channel Element (CCE) is a group of resources that can be used to send a PDCCH. One CCE consists of 9 REGs. Downlink Control Information (DCI) may be sent on a PDCCH using a certain aggregation level. An aggregation level is a group of L CCEs that are used for the transmission of the DCI, where L can be 1, 2, 4, or 8 for example. The more CCEs that are used, the more robust is the transmission, i.e., the more bits are used for sending the DCI on the PDCCH to the UE, and the more certain it is that the DCI is received and understood by the UE. In New Radio (NR), i.e., 5G, a REG is a group of 12 REs, one CCE consists of 6 REGs and L can be 1, 2, 4, 8 or 16.

In order to use the communication resources efficiently for transmission of DCI on a PDCCH, PDCCH link adaptation is needed so that the most efficient aggregation level can be used. If the channel quality is good, a low number of CCEs, i.e. a low aggregation level should be used, and vice versa.

The PDCCH is transmitted using specific time-frequency resources called a Control Resource Set (CORESET). Those time-frequency resources are different from the time-frequency resources that are used to transmit traffic data on a Physical Downlink Shared Channel (PDSCH). This means that the interference on the CORESET may be different than the interference on resources used for transmitting the PDSCH, and hence the channel quality may be different.

There are no channel quality measurement reports such as Channel State Information (CSI) specific to PDCCH, so the existing PDCCH link adaption algorithms today use CSI despite that it reflects the quality of resources other than the PDCCH such as the time-frequency resources used for transmitting PDSCH, which as mentioned may have a different channel quality. Those link adaptation algorithms therefore have to try to find the offset between the channel quality of the PDCCH and the channel quality of the data channel, i.e. PDSCH. Further, the offset often changes over time based on e.g., how many PDCCH resources that are used for the downlink in a time period, or how large the PDSCH transmissions are. To be able to handle the difference in channel quality between the PDSCH and the PDCCH, some existing algorithms use an outer loop that performs a positive channel adjustment every time a PDCCH has been successfully decoded and a negative adjustment if unsuccessful. Such an algorithm works best when the expected loss rate is near 50% as the step size for positive and negative adjustment can be the same. For the PDCCH, where a success rate of 99% or more is requested, one loss will have a very large impact on the adjustment which will take a very long time to recover from (e.g. 99 successes). Such asymmetrical adjustments are also sensitive when errors are closely grouped together in time. For example, if there is a temporary fading dip in the channel, we may lose 5 consecutive PDCCH, which will then adjust 5*99 steps, while these errors in fact only relate to a single problem event. Such algorithms are also very slow to react to rapidly changing conditions. Also, as long as the algorithm only operates on actual data transmission, each lost PDCCH will lead to increased latency, which will have a negative impact on user experience. Consequently, there is a need of an improved way of performing link adaptation on a PDCCH.

### SUMMARY

It is an object of the invention to address at least some of the problems and issues outlined above. It is an object of embodiments of the invention to facilitate link adaptation on a PDCCH. It is another object of embodiments to select a suitable CCE aggregation level for transmitting on a PDCCH. It is possible to achieve these objects and others by using methods and network nodes as defined in the attached independent claims.

According to one aspect, a method is provided that is performed by a network node of a wireless communication network for handling transmission on a PDCCH on a CORESET to a UE. The method comprises transmitting, to the UE, a first DCI in the PDCCH using a first CCE aggregation level, the first DCI instructing the UE to send a transmission to the network node on a first uplink resource indicated by the first DCI. The method further comprises transmitting, to the UE, a second DCI in the PDCCH using a second CCE aggregation level that is different from the first CCE aggregation level, the second DCI instructing the UE to send a transmission to the network node on a second uplink resource indicated by the second DCI. The method further comprises determining whether any transmission was received from the UE on the first uplink resource and determining whether any transmission was received from the UE on the second uplink resource. The method further comprises determining, based on the determining whether any transmission was received from the UE on the first uplink resource and on the determining whether any transmission was received from the UE on the second uplink resource, which of the first and the second CCE aggregation level to use for a later PDCCH transmission.

According to another aspect, a network node is provided that is configured to operate in a wireless communication network and configured for handling transmission on a PDCCH on a CORESET to a UE. The network node comprises a processing circuitry and a memory. Said memory contains instructions executable by said processing circuitry, whereby the network node is operative for transmitting, to the UE, a first DCI in the PDCCH using a first CCE aggregation level, the first DCI instructing the UE to send a transmission to the network node on a first uplink resource indicated by the first DCI. The network node is further operative for transmitting, to the UE, a second DCI in the PDCCH using a second CCE aggregation level that is different from the first CCE aggregation level, the second DCI instructing the UE to send a transmission to the network node on a second uplink resource indicated by the second DCI. The network node is further operative for determining whether any transmission was received from the UE on the first uplink resource, determining whether any transmission was received from the UE on the second uplink resource, and determining, based on the determining whether any transmission was received from the UE on the first uplink resource and on the determining whether any transmission was received from the UE on the second uplink resource, which of the first and the second CCE aggregation level to use for a later PDCCH transmission.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic diagram of a wireless communication network in which the present invention may be used.

FIG. 2 is a signaling diagram illustrating a DL assignment procedure according to prior art.

FIG. 3 is a signaling diagram illustrating an UL grant procedure according to prior art.

FIG. 4 is a flow chart illustrating a method performed by a network node, according to possible embodiments.

FIG. 5 is a signaling diagram illustrating an example of a procedure performed by a network node, according to further possible embodiments.

FIG. 6 is a block diagram illustrating a network node in more detail, according to further possible embodiments.

### DETAILED DESCRIPTION

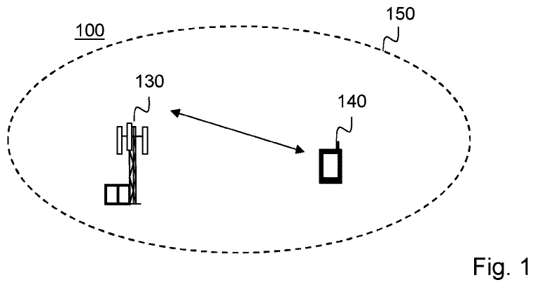

FIG. 1 shows a wireless communication network 100 comprising a radio access network (RAN) node aka network node 130 that is in, or is adapted for, wireless communication with a wireless communication device aka wireless device or UE 140. The network node 130 provides radio access in a cell 150 covering a geographical area in which the UE 140 is currently situated.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network node 130 may be any kind of network node that can provide wireless access to a wireless device 140 alone or in combination with another network node. Examples of network nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The wireless device 140 may be any type of device capable of wirelessly communicating with a network node 130 using radio signals. For example, the wireless device 140 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE), an Internet of Things (IoT) device, etc.

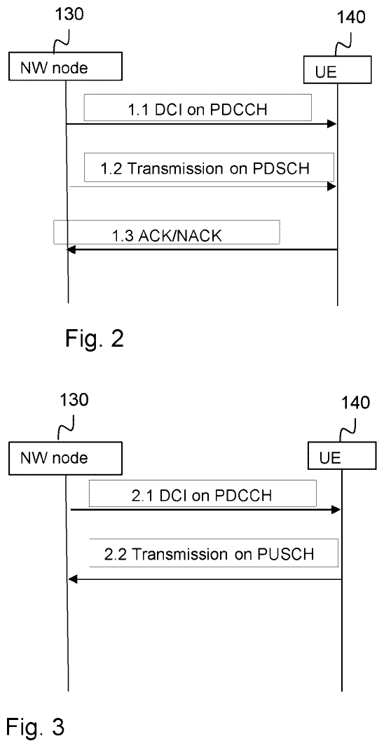

FIG. 2 shows a DL assignment procedure according to prior art. The network node 130 sends 1.1 downlink control information (DCI) on a PDCCH to the UE 140. The DCI comprises information on downlink (DL) resources, i.e., time-frequency resources on which a DL transmission is to be sent by the network node 130 to the UE 140. The DCI further comprises information on uplink (UL) resources on which the UE 140 is to respond to whether it received anything on the DL resources. After the sending 1.1 of the DCI, the network node 130 transmits 1.2 data on a PDSCH on the DL resources indicated in the information communicated to the UE in the DCI. The UE 140 responds 1.3 to the transmission 1.2 by sending to the network node 130 an ACK if the data was received properly or a NACK if the data was not received properly. The ACK/NACK is sent in the UL resources indicated in the information communicated to the UE in the DCI. The ACK/NACK may be sent on a Physical Uplink Shared Channel (PUSCH) or a Physical Uplink Control Channel (PUCCH).

FIG. 3 shows an UL Grant procedure according to prior art. The network node 130 sends 2.1 DCI on a PDCCH to the UE 140. The DCI comprises information on UL resources on which an UL transmission is to be sent by the UE 140. As a result, the UE sends 2.2 the UL transmission to the network node 130 on the UL resources indicated in the information in the DCI. *The UL transmission is sent on a PUSCH.

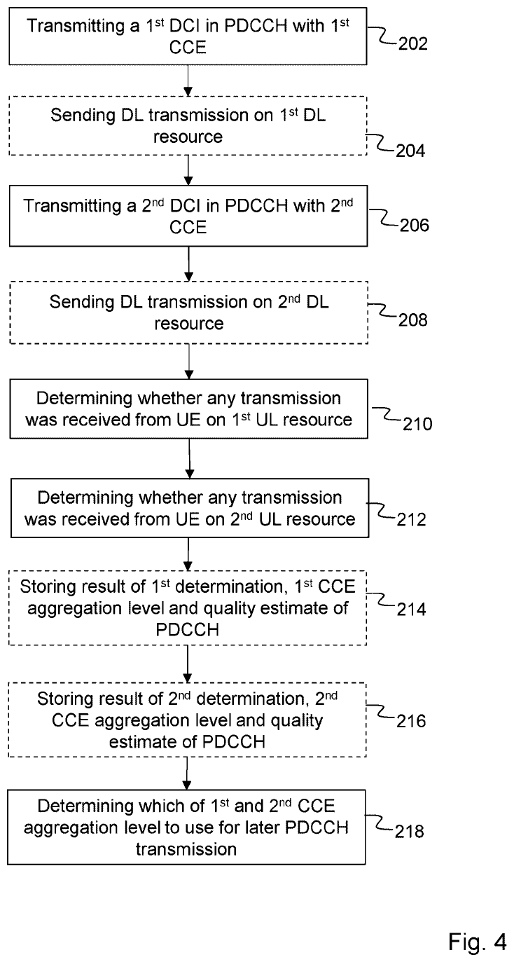

FIG. 4, in conjunction with FIG. 1, shows a method performed by a network node 130 of a wireless communication network 100 for handling transmission on a PDCCH on a CORESET to a UE 140. The method comprises transmitting 202, to the UE 140, a first DCI in the PDCCH using a first CCE aggregation level, the first DCI instructing the UE 140 to send a transmission to the network node 130 on a first uplink resource indicated by the first DCI. The method further comprises transmitting 206, to the UE 140, a second DCI in the PDCCH using a second CCE aggregation level that is different from the first CCE aggregation level, the second DCI instructing the UE 140 to send a transmission to the network node 130 on a second uplink resource indicated by the second DCI.

The method further comprises determining 210 whether any transmission was received from the UE 140 on the first uplink resource and determining 212 whether any transmission was received from the UE 140 on the second uplink resource.

The method further comprises determining 218, based on the determining 210 whether any transmission was received from the UE 140 on the first uplink resource and on the determining 212 whether any transmission was received from the UE 140 on the second uplink resource, which of the first and the second CCE aggregation level to use for a later PDCCH transmission.

The first and/or second DCI may be a DL assignment or an UL grant. The DL assignment includes information on both DL resource(s) on which a DL transmission is sent and UL resource(s) on which the UE is to respond to whether it received anything on the DL resource(s). The UL Grant includes instructions to the UE to send information on certain UL resource(s). In case the UE does not send anything on the dedicated first/second UL resource(s) of the DL assignment or UL Grant, e.g., the UE does not send any ACK/NACK in response to a PDSCH transmission (DL assignment), or does not transmit anything on the PUSCH (UL grant) it is an indication to the network node that the UE did not receive the DCI of the DL assignment or the UL grant correctly, and therefore that the tested CCE aggregation level did not work properly. Further, since the UE receives the first and second DCI on the PDCCH by performing blind detection attempts there is a neglective impact on UE battery lifetime. Further, as well as testing a first and a second CCE aggregation level, a third CCE aggregation level different from the first and second CCE aggregation level may be tested in the same way as above. Also, it is possible to test also a fourth and even a fifth CCE aggregation level in the same way.

The first DCI and/or the second DCI can contain regular control data instructing of a DL or UL data transmission. Alternatively, the first and/or the second DCI can contain only test data. In other words, the first and/or second DCI is then a probe, which is only used for testing a certain CCE aggregation level. I.e. it triggers a sending DL or UL but the sending is only a test, does not contain traffic data.

According to an embodiment, the method further comprises storing 214 the result of the determination 210 of whether any transmission was received from the UE 140 on the first uplink resource together with the first CCE aggregation level and a quality estimate of the PDCCH, and storing 216 the result of the determination 212 of whether any transmission was received from the UE 140 on the second uplink resource together with the second CCE aggregation level and the quality estimate of PDCCH. Further, the determining 218 which of the first and the second CCE aggregation level to use for the later PDCCH transmission is performed based on a quality estimate of the PDCCH at the later PDCCH transmission and the stored 214 result of the determination of whether any transmission was received from the UE 140 on the first uplink resource, the first CCE aggregation level and its stored quality estimate and the stored 216 result of the determination of whether any transmission was received from the UE 140 on the second uplink resource, the second CCE aggregation level and its stored quality estimate.

By storing the result of earlier determinations and the quality that was experienced then, it is possible to select a CCE aggregation level based on statistics from earlier tests of CCE aggregation levels so that a suitable CCE aggregation level can be used as functioned well for an earlier similar PDCCH quality. The quality estimate of the PDCCH could be for example Raw Bit Information Rate (RBIR), Signal to Interference and Noise Ratio (SINR), Signal to Noise Ratio (SNR), etc. RBIR may be determined based on for example SINR, and type of modulation used.

According to another embodiment, the first DCI is only used for probing, i.e. testing, PDCCH quality and/or the second DCI is only used for probing PDCCH quality. In other words, the first DCI and/or the second DCI is a probe that is only sent in order to trigger a response from the UE to test whether a certain aggregation level on the PDCCH is successful or not. The first DCI and/or the second DCI does not trigger any sending of traffic data neither DL nor UL. The first and/or second DCI only triggers sending of test data UL or DL, such as a Medium Access Control (MAC) padding Packet Data Unit (PDU). The first DCI and/or the second DCI may comprise probe data or a sequence of probe data. Hereby it is possible to probe different CCE aggregation levels without risking losing any traffic data during the probing.

According to another embodiment, when the first DCI is a Downlink Assignment, the first DCI triggers a transmission of traffic data to the UE 140 on a Physical Downlink Shared Channel, PDSCH. Alternatively, when the first DCI is an Uplink Grant, the transmission that the first DCI instructs the UE 140 to send in the first uplink resource is a transmission of traffic data from the UE to the network node 130. Further, when the second DCI is a Downlink Assignment, the second DCI triggers a transmission of a MAC padding PDU to the UE on the PDSCH or a re-transmission of acknowledgement data on the PDSCH. Alternatively, when the second DCI is an Uplink Grant, the transmission that the second DCI instructs the UE to send in the second uplink resource is a re-transmission of data for which a positive acknowledgement has been received.

In this embodiment traffic data is triggered to be sent by the first DCI, and the second DCI is only used for probing of whether another CCE aggregation level could have been used as well. Preferably, the second DCI could then be sent with less CCE elements than the first DCI, that is with a lower CCE aggregation level than the first DCI. In other words, the second CCE aggregation level would be lower than the first CCE aggregation level. Then no traffic data can be lost in case the second DCI is not received properly, and still traffic data is triggered to be sent by the PDCCH using the first, higher CCE aggregation level. Also, for a further PDCCH sending, it can be determined whether the second, lower CCE aggregation level can be used for that sending. In the case of the first/second DCI being a Downlink assignment, the transmission that the first/second DCI instructs the UE 140 to send in the first/second uplink resource is an ACK or NACK, depending on whether the transmission on the PDSCH was detected properly by the UE or not.

According to another embodiment, the first DCI is a downlink assignment including an indication of a downlink transmission to the UE 140 on a first downlink resource, which downlink transmission the UE 140 is instructed to respond to in the first uplink resource. Further, the method comprises sending 204, to the UE 140, the downlink transmission on the first downlink resource. In this case, the “any transmission” that it is determined 210 whether it was received on the first uplink resource could be an ACK or NACK of whether any data was received on the first DL resource.

According to an alternative embodiment, the downlink transmission sent 204 on the first downlink resource is a PDSCH transmission containing only a MAC padding PDU, or a PDSCH transmission containing traffic data pending in a buffer of the network node 130, or a PDSCH transmission indicating a re-transmission of already acknowledged or correctly received data.

According to another embodiment, the second DCI is a downlink assignment including an indication of a downlink transmission to the UE 140 on a second downlink resource, which downlink transmission the UE 140 is instructed to respond to in the second uplink resource. Further, the method comprises sending 208, to the UE 140, the downlink transmission on the second downlink resource.

According to an alternative embodiment, the downlink transmission sent 208 on the second downlink resource is a PDSCH transmission containing only a MAC padding PDU, or a PDSCH transmission containing traffic data pending in a buffer of the network node 130, or a PDSCH transmission indicating a re-transmission of already acknowledged or correctly received data.

According to yet another embodiment, the first DCI is an uplink grant and the first uplink resource is on a PUSCH, and/or the second DCI is an uplink grant and the second uplink resource is on a PUSCH.

According to an alternative embodiment, the uplink grant of the first DCI contains an instruction to the UE 140 to only send Channel State Information, CSI, on the first uplink resource, and/or the uplink grant of the second DCI contains an instruction to the UE 140 to only send CSI on the second uplink resource.

According to yet another embodiment, the transmitting 202, 206 of the first DCI and the second DCI is triggered in response to detection of a PDCCH failure. When the first DCI and the second DCI is triggered, the method starts, and different CCE aggregation levels are tested and evaluated. Hence, when a PDCCH failure is detected, the different CCE aggregation levels are tested in order to evaluate which CCE aggregation level to use for the coming transmission.

According to still another embodiment, the method further comprises obtaining information on PDCCH load on a first cell 150 in which the UE 140 resides and/or information on PDCCH load on one or more cells that are neighbors to the first cell 150. Further, the determining 218 which of the first and the second CCE aggregation level to use for the later PDCCH transmission is based also on the information on PDCCH load on the first cell 150 and/or on the information on PDCCH load on the one or more neighboring cells. PDCCH load information may e.g., be how large percentage of the PDCCH resources that is used in the cell. The PDCCH load information can be shared between cells either using a proprietary interface or using a standardized message.

According to yet another embodiment, the method further comprises obtaining information on PDCCH load on a first cell 150 in which the UE 140 resides and/or information on PDCCH load on one or more cells that are neighbors to the first cell 150. Further, the transmitting 202, 206 of the first DCI and the second DCI is triggered in response to determining that the PDCCH load on the first cell 150 has changed with more than a first threshold, or in response to determining that the PDCCH load on the one or more neighboring cells has changed with more than a second threshold. The first and second threshold may be the same threshold or different thresholds. The change of PDCCH load is determined by comparing one information on PDCCH load with a previous information on PDCCH load for the same cell. When the first DCI and the second DCI is triggered, the method starts, and different CCE aggregation levels are tested and evaluated. Hence, each time the PDCCH load has changed with more than a set threshold, the different CCE aggregation levels are tested in order to evaluate which CCE aggregation level to use for the coming transmissions.

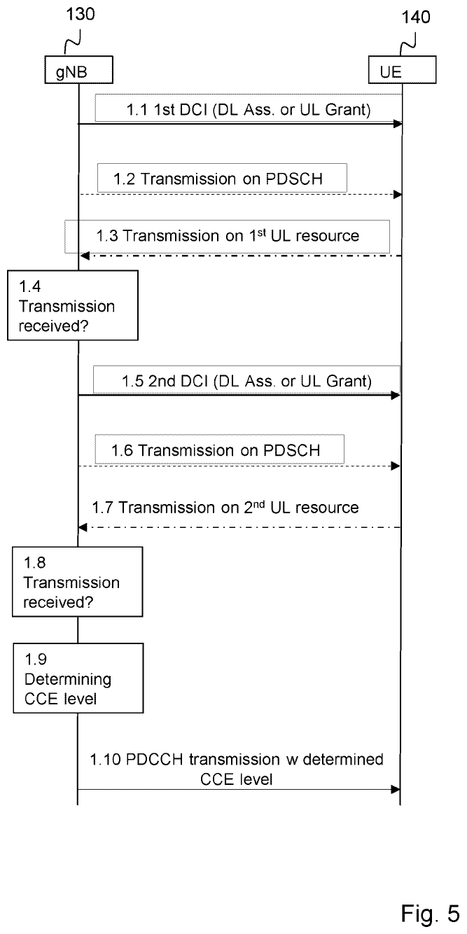

FIG. 5 shows an embodiment of a method for handling transmissions on a PDCCH. The method starts by the network node, in this case exemplified by a gNodeB (gNB) 130, sending 1.1 a first DCI on a PDCCH using a first CCE aggregation level, the first DCI containing a first uplink resource to be used by the UE. In case the first DCI is a DL assignment, the gNB then transmits 1.2 data on a DL communication resource of a PDSCH, which DL resource is indicated in the first DCI. In case the UE 140 correctly acquired the first DCI, the UE will respond to the transmission on the PDSCH by transmitting 1.3 an ACK or a NACK to the gNB 130 in the first uplink resource indicated in the first DCI. Whether an ACK or NACK is sent depends on whether the UE understood the transmission 1.2 on the PDSCH or not. In case the UE 140 did not acquire the first DCI correctly, the UE will not send anything in response to the transmission 1.2 as the UE will not understand that the transmission 1.2 was to itself. So, this means that the gNB 130 by determining 1.4 whether any transmission 1.3 was received on the first uplink resource indicated in the first DCI, also can determine whether the first DCI was acquired correctly, i.e., whether the first CCE aggregation level worked properly. Observe that it does not matter whether an ACK or a NACK is received by the gNB. Both indicates that the first DCI was acquired correctly. The NACK would indicate that the data transmitted 1.2 on the PDSCH was not received correctly.

In case the first DCI is an uplink grant, the gNB 130 will not perform any DL data transmission 1.2 on the PDSCH. Instead, the UE is instructed to transmit 1.3 data on the first uplink resource indicated in the first DCI. In case the UE 140 did not acquire the first DCI properly, the UE will not transmit any such data on the first UL resource. So, this means that the gNB 130, by determining 1.4 whether any transmission 1.3 was received on the first uplink resource indicated in the first DCI, also can determine whether the first DCI was acquired correctly, i.e., whether the UE may decode the DCI when transmitted with the first CCE aggregation level.

Further, the gNB 130 sends 1.5 a second DCI on a PDCCH using a second CCE aggregation level, the second DCI containing a second uplink resource to be used by the UE. In case the second DCI is a DL assignment, the gNB then transmits 1.6 data on a PDSCH on a DL communication resource indicated in the second DCI. In case the UE 140 correctly acquired the second DCI, the UE will respond to the transmission 1.6 on the PDSCH by transmitting 1.7 an ACK or a NACK to the gNB 130 in the second uplink resource indicated in the second DCI. In case the UE 140 did not acquire the second DCI correctly, the UE will not send any response to the transmission 1.6 as the UE will not understand that the transmission 1.6 was to itself. So, this means that the gNB 130 by determining 1.8 whether any transmission was received on the second uplink resource indicated in the second DCI, also can determine whether the second DCI was received correctly by the UE, i.e., whether the UE is capable of correctly acquiring the DCI when transmitted according to the second CCE aggregation level. Observe that it does not matter whether an ACK or a NACK is received by the gNB. Both indicates that the second DCI was acquired correctly by the UE. The NACK would indicate that the data transmitted 1.6 on the PDSCH was not received correctly.

In case the second DCI is an uplink grant, the gNB does not perform any DL data transmission 1.6 on the PDSCH. Instead, the UE is instructed to transmit 1.7 data on the second uplink resource as is indicated in the second DCI. In case the UE 140 did not receive or detect correctly the second DCI, the UE will not transmit any such UL data on the second UL resource. So, this means that the gNB 130, by determining 1.8 whether any transmission 1.7 was received from the UE on the second uplink resource indicated in the second DCI, can determine whether the second DCI was received correctly, i.e., whether the UE is capable of acquiring the DCI as transmitted with the second CCE aggregation level.

Thereafter, the gNB 130 determines 1.9 which of the first and the second CCE aggregation level to use for a later PDCCH transmission, based on the determining 1.4 whether any transmission was received from the UE 140 on the first uplink resource and the determining 1.8 whether any transmission was received from the UE 140 on the second uplink resource. This may be done by determining 1.9 to use the lowest CCE aggregation level that the UE was capable of acquiring and therefore resulted in a received transmission 1.3 or 1.7 on the UL resource indicated in its respective DCI. Thereafter, a following PDCCH transmission 1.10 is performed with the determined CCE aggregation level.

Observe that a DCI may be sent for each available CCE aggregation level, e.g., four or five different levels, in the same ways as described above for two different CCE aggregation levels.

According to an embodiment, the first and second DCI can be sent staggered in time or alternatively they are sent within the same time slot. This means that the steps 1.5-1.8 may be performed at least partly simultaneously as the steps 1.1-1.4. A special case of multiplexing a first and second DCI may be to transmit both a DL assignment and an UL grant to the same UE in the same slot, which when the first and second DCI are received correctly, could multiplex the transmissions on the first and second UL resource into the PUSCH.

According to an embodiment, the first and/or the second DCI are sent as probes., i.e. they will not trigger any transmission of traffic data but is only used as tests of the PDCCH to see which CCE aggregation levels that works. These probes can trigger either a downlink PDSCH transmission or uplink PUSCH transmission, as mentioned above for the first and second DCI. Since the probes are used to collect information about the success chance of each CCE aggregation level, each probe needs to trigger something that will provide a response, i.e. transmissions 1.3 and 1.7 on the first/second UL resource, e.g. either a PUSCH transmission or a Hybrid Automatic Repeat Request (HARQ) ACK/NACK on PUSCH/PUCCH.

To make sure such a response is triggered from the UE, i.e. a transmission 1.3 and 1.7, when the PDCCH is received and understood by the UE, the gNB 130 can for example send (as 1.2 and/or 1.6 of FIG. 5) a PDSCH transmission containing only a MAC padding PDU, or alternatively send a PDSCH transmission containing actual data that is pending in the buffer. Note that it is less desirable to send actual data as a probing PDCCH may have lower success rate and therefore risk delaying the data in question. Still alternatively, the gNB can send a PDSCH transmission indicating a re-transmission of already ACK: ed or correctly received data. The re-transmission assignment could therefore be kept small, which means that impact on overall performance will also be small.

Alternatively, to make sure such a response is triggered from the UE, i.e. a transmission 1.3 and 1.7, the first/second DCI can trigger a PUSCH transmission indicating a re-transmission of correctly received data. Alternatively, the first/second DCI triggers a PUSCH transmission 1.3/1.7 containing only CSI. Note that if the UE is configured with a Radio Resource Control (RRC) parameter skipTxDynamic, and the UE has a PUCCH scheduling request (SR) allocation in the same slot, it may be wise to skip probing in this specific slot as the UE is allowed to skip a CSI request in a slot where an SR is triggered. The base station may instead send the probe, but do not update the statistics if an SR is received in the slot where the CSI transmission was expected on PUSCH.

Alternatively, to make sure such a response is triggered from the UE, i.e. a transmission 1.3 and 1.7 on the respective UL resource, if the UE has an active Configured Grant, the gNB 130 may trigger a configured grant activation with the PDCCH which may either repeat the existing activation, or update the configured grant with a new combination of modulation an coding scheme (MCS).

According to an embodiment, when the respective probe is transmitted 1.1 and 1.5, information is stored about which CCE aggregation level was used together with a quality estimate of the PDCCH at the time the probe was sent.

The quality estimate may be raw bit information rate (RBIR). Further, according to a variant of this embodiment, when the gNB can detect the above-mentioned response, i.e. the transmission 1.3 and 1.7 on the respective first and second UL resource, this signifies that the PDCCH was successfully received. When no transmission can be detected this indicates unsuccessful PDCCH decoding. This information, i.e. successful or unsuccessful PDCCH reception, is stored together with the already stored quality estimate and CCE aggregation level into a data structure where the expected PDCCH decoding success rate for each pair of quality estimate and CCE aggregation level can be retrieved.

When the gNB 130 later wants to transmit anything on the PDCCH, the current quality estimate is used to look up a CCE aggregation level with a sufficiently large, expected success rate and this is used in the transmission. For each such performed link adaptation, the result is stored in the same way as for the probes in order to build a more accurate link success rate estimate.

As the PDCCH link adaptation usually operates on a very high expected success rate, e.g., 99%, initialization of the data structure will have a large impact on how successful the link adaptation will be. To avoid issues, CCE aggregation levels may be avoided that have received at least one decoding failure, until a significant amount of data has been collected for each CCE aggregation level.

According to an embodiment, probing is repeated at a certain interval in order to improve the data set, for example for CCE aggregation levels that have not been used for regular data transmissions or have not been used very frequently. This interval may be periodical, done when there are a lot of unused PDCCH resources, or based on some event that is expected to change the success rate. Such events may include: a change in Reference Signal Received Power (RSRP) for this UE, a change in traffic activity for the UE, e.g. after longer periods of inactivity, a change in the cell load for the PDCCH. A probing could also be triggered every time a PDCCH failure is seen. A probing could also be triggered by PDCCH errors on PDCCH for regular data transmission, for example if two consecutive PDCCH errors occur. If the cell in which the UE resides is heavily loaded and there are few or no PDCCH or PDSCH/PUSCH resources available for probing, the system can skip probing until more resources become available. Once more information of PDCCH decoding success rate for pairs of quality estimate and CCE aggregation level have been collected, probing might only consider a subset of the CCE aggregation levels in each probe round, e.g. a currently used CCE aggregation level and the one above and below it.

According to an embodiment, to further improve the accuracy of the PDCCH link adaptation, the network node may obtain PDCCH load information in the cell in which the UE resides, and/or PDCCH load information in cells that are neighbors to the cell in which the UE resides. The PDCCH load information may comprise PDCCH load and/or PDCCH load variations, e.g. a standard deviation over a certain time. The PDCCH load information can be used as input to the link adaptation. In a first embodiment, the PDCCH load information is used to better estimate the interference and use a suitable backoff for that. In a second embodiment, the PDCCH load information is used to detect changes in the neighborhood, which should be an indication to trigger a round of probes, i.e. to trigger that embodiments of the described method is performed. Such communicated information may also contain information about beamforming usage on the cell. This communicated PDCCH load information is also intended to be used by the PDCCH link adaptation for estimating the quality difference between the PDSCH and the PDCCH, e.g. to estimate RBIR difference between the PDSCH and the PDCCH. This since the CSI information transmitted on the cell is usually measured only on the PDSCH and this may differ significantly from the PDCCH quality in some cases. Such load information may be used to e.g. lower the RBIR estimate for the PDCCH if we see a higher reported PDCCH load than PDSCH load and vice versa.

According to an embodiment, if there are multiple CORESETs configured, probing is performed separately for each CORESET.

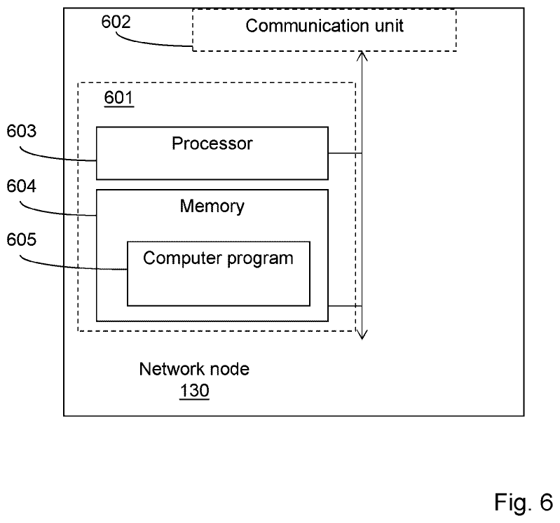

FIG. 6, in conjunction with FIG. 1, describes a network node 130 configured to operate in a wireless communication network 100, and configured for handling transmission on a PDCCH on a CORESET to a UE 140. The network node 130 comprises a processing circuitry 603 and a memory 604. Said memory contains instructions executable by said processing circuitry, whereby the network node 130 is operative for transmitting, to the UE 140, a first DCI in the PDCCH using a first CCE aggregation level, the first DCI instructing the UE 140 to send a transmission to the network node 130 on a first uplink resource indicated by the first DCI. The network node is further operative for transmitting, to the UE 140, a second DCI in the PDCCH using a second CCE aggregation level that is different from the first CCE aggregation level, the second DCI instructing the UE 140 to send a transmission to the network node 130 on a second uplink resource indicated by the second DCI. The network node is further operative for determining whether any transmission was received from the UE 140 on the first uplink resource, determining whether any transmission was received from the UE 140 on the second uplink resource, and determining, based on the determining whether any transmission was received from the UE 140 on the first uplink resource and on the determining whether any transmission was received from the UE 140 on the second uplink resource, which of the first and the second CCE aggregation level to use for a later PDCCH transmission.

According to an embodiment, the network node 130 is further operative for storing the result of the determination of whether any transmission was received from the UE 140 on the first uplink resource together with the first CCE aggregation level and a quality estimate of the PDCCH, and storing the result of the determination of whether any transmission was received from the UE 140 on the second uplink resource together with the second CCE aggregation level and the quality estimate of PDCCH. Further, the determining which of the first and the second CCE aggregation level to use for the later PDCCH transmission is performed based on a quality estimate of the PDCCH at the later PDCCH transmission and the stored result of the determination of whether any transmission was received from the UE 140 on the first uplink resource, the first CCE aggregation level and its stored quality estimate and the stored result of the determination of whether any transmission was received from the UE 140 on the second uplink resource, the second CCE aggregation level and its stored quality estimate.

According to another embodiment, the first DCI is only used for probing PDCCH quality and/or wherein the second DCI is only used for probing PDCCH quality.

According to another embodiment, the network node 130 is further operative for, when the first DCI is a downlink assignment, the first DCI triggering a transmission of traffic data to the UE 140 on a PDSCH, or when the first DCI is an uplink grant, the transmission that the first DCI instructs the UE 140 to send in the first uplink resource is a transmission of traffic data from the UE to the network node 130, and when the second DCI is a downlink assignment, the second DCI triggering a transmission of a MAC padding PDU to the UE on the PDSCH or a re-transmission of acknowledgement data on the PDSCH, or when the second DCI is an uplink grant, the transmission that the second DCI instructs the UE to send in the second uplink resource is a re-transmission of acknowledgement data.

According to yet another embodiment, the first DCI is a downlink assignment including an indication of a downlink transmission to the UE 140 on a first downlink resource, which downlink transmission the UE 140 is instructed to respond to in the first uplink resource. Further, the network node 130 is operative for sending, to the UE 140, the downlink transmission on the first downlink resource.

According to yet another embodiment, the network node is operative for the sending of the downlink transmission on the first downlink resource by sending a PDSCH transmission containing only a MAC padding PDU, or a PDSCH transmission containing traffic data pending in a buffer of the network node 130, or a PDSCH transmission indicating a re-transmission of already acknowledged or correctly received data.

According to still another embodiment, the second DCI is a downlink assignment including an indication of a downlink transmission to the UE 140 on a second downlink resource, which downlink transmission the UE 140 is instructed to respond to in the second uplink resource. Further, the network node 130 is operative for sending, to the UE 140, the downlink transmission on the second downlink resource.

According to yet another embodiment, the network node is operative for the sending of the downlink transmission on the second downlink resource by sending a PDSCH transmission containing only a MAC padding PDU, or a PDSCH transmission containing traffic data pending in a buffer of the network node 130, or a PDSCH transmission indicating a re-transmission of already acknowledged or correctly received data.

According to another embodiment, the first DCI is an uplink grant and the first uplink resource is on a PUSCH, and/or the second DCI is an uplink grant and the second uplink resource is on a PUSCH.

According to another embodiment, the uplink grant of the first DCI contains an instruction to the UE 140 to only send CSI on the first uplink resource, and/or the uplink grant of the second DCI contains an instruction to the UE 140 to only send CSI on the second uplink resource.

According to another embodiment, the network node is further operative for triggering the transmitting of the first DCI and the second DCI in response to detection of a PDCCH failure.

According to yet another embodiment, the network node is further operative for obtaining information on PDCCH load on a first cell 150 in which the UE 140 resides and/or information on PDCCH load on one or more cells that are neighbors to the first cell 150. Further, the network node 130 is operative for the determining of which of the first and the second CCE aggregation level to use for the later PDCCH transmission based also on the information on PDCCH load on the first cell 150 and/or on the information on PDCCH load on the one or more neighboring cells.

According to another embodiment, the network node is further operative for obtaining information on PDCCH load on a first cell 150 in which the UE 140 resides and/or information on PDCCH load on one or more cells that are neighbors to the first cell 150. The network node 130 is further operative for triggering the transmitting of the first DCI and the second DCI in response to determining that the PDCCH load on the first cell 150 has changed with more than a first threshold, or in response to determining that the PDCCH load on the one or more neighboring cells has changed with more than a second threshold.

According to other embodiments, the network node 130 may further comprise a communication unit 602, which may be considered to comprise conventional means for wireless communication with the wireless device 140, such as a transceiver for wireless transmission and reception of signals in the communication network. The communication unit 602 may also comprise conventional means for communication with other network nodes of the wireless communication network 100. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the network node 130 to perform the steps described in any of the described embodiments of the network node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the network node 130 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a network node of a wireless communication network for handling transmission on a Physical Downlink Control Channel, PDCCH, on a Control Resource Set, CORESET, to a User Equipment, UE the method comprising:
transmitting, to the UE a first Downlink Control Information, DCI, in the PDCCH using a first Control Channel Element, CCE, aggregation level, the first DCI instructing the UE to send a transmission to the network node on a first uplink resource indicated by the first DCI;
transmitting, to the UE, a second DCI in the PDCCH using a second CCE aggregation level that is different from the first CCE aggregation level, the second DCI instructing the UE to send a transmission to the network node on a second uplink resource indicated by the second DCI;
determining whether any transmission was received from the UE on the first uplink resource;
determining whether any transmission was received from the UE on the second uplink resource, and
determining , based on the determining whether any transmission was received from the UE on the first uplink resource and on the determining whether any transmission was received from the UE on the second uplink resource, which of the first and the second CCE aggregation level to use for a later PDCCH transmission.

2. Method according to claim 1, further comprising:
storing the result of the determination of whether any transmission was received from the UE on the first uplink resource together with the first CCE aggregation level and a quality estimate of the PDCCH;
storing the result of the determination of whether any transmission was received from the UE on the second uplink resource together with the second CCE aggregation level and the quality estimate of PDCCH, and
wherein the determining which of the first and the second CCE aggregation level to use for the later PDCCH transmission is performed based on a quality estimate of the PDCCH at the later PDCCH transmission and the stored result of the determination of whether any transmission was received from the UE on the first uplink resource, the first CCE aggregation level and its stored quality estimate and the stored result of the determination of whether any transmission was received from the UE on the second uplink resource, the second CCE aggregation level and its stored quality estimate.

3. (canceled)

4. Method according to claim 1, wherein when the first DCI is a downlink assignment, the first DCI triggers a transmission of traffic data to the UE on a Physical Downlink Shared Channel, PDSCH, or when the first DCI is an uplink grant, the transmission that the first DCI instructs the UE to send in the first uplink resource is a transmission of traffic data from the UE to the network node, and when the second DCI is a downlink assignment, the second DCI triggers a transmission of a MAC padding PDU to the UE on the PDSCH or a re-transmission of acknowledgement data on the PDSCH, or when the second DCI is an uplink grant, the transmission that the second DCI instructs the UE to send in the second uplink resource is a re-transmission of acknowledgement data.

5. Method according to claim 1, wherein the first DCI is a downlink assignment including an indication of a downlink transmission to the UE on a first downlink resource, which downlink transmission the UE is instructed to respond to in the first uplink resource, the method further comprises:
sending, to the UE, the downlink transmission on the first downlink resource.

6. Method according to claim 5, wherein the downlink transmission sent on the first downlink resource is a PDSCH transmission containing only a
MAC padding PDU, or a PDSCH transmission containing traffic data pending in a buffer of the network node, or a PDSCH transmission indicating a retransmission of already acknowledged or correctly received data.

7. Method according to claim 1, wherein the second DCI is a downlink assignment including an indication of a downlink transmission to the UE on a second downlink resource, which downlink transmission the UE is instructed to respond to in the second uplink resource, the method further comprises:
sending, to the UE, the downlink transmission on the second downlink resource.

8. Method according to claim 7, wherein the downlink transmission sent on the second downlink resource is a PDSCH transmission containing only a MAC padding PDU, or a PDSCH transmission containing traffic data pending in a buffer of the network node, or a PDSCH transmission indicating a retransmission of already acknowledged or correctly received data.

9. Method according to claim 1, wherein the first DCI is an uplink grant and the first uplink resource is on a PUSCH, and/or the second DCI is an uplink grant and the second uplink resource is on a PUSCH.

10-11. (canceled)

12. Method according to claim 1, further comprising:
obtaining information on PDCCH load on a first cell in which the UE resides and/or information on PDCCH load on one or more cells that are neighbors to the first cell, and
wherein the determining which of the first and the second CCE aggregation level to use for the later PDCCH transmission is based also on the information on PDCCH load on the first cell and/or on the information on PDCCH load on the one or more neighboring cells.

13. Method according to claim 1, further comprising:
obtaining information on PDCCH load on a first cell in which the UE resides and/or information on PDCCH load on one or more cells that are neighbors to the first cell, and
wherein the transmitting of the first DCI and the second DCI is triggered in response to determining that the PDCCH load on the first cell has changed with more than a first threshold, or in response to determining that the PDCCH load on the one or more neighboring cells has changed with more than a second threshold.

14. A network node configured to operate in a wireless communication network, and configured for handling transmission on a Physical Downlink Control Channel, PDCCH, on a Control Resource Set, CORESET, to a User Equipment, UE, the network node comprising a processing circuitry and a memory, said memory containing instructions executable by said processing circuitry, whereby the network node is operative for:
transmitting, to the UE, a first Downlink Control Information, DCI, in the PDCCH using a first Control Channel Element, CCE, aggregation level, the first DCI instructing the UE to send a transmission to the network node on a first uplink resource indicated by the first DCI;
transmitting, to the UE ,a second DCI in the PDCCH using a second CCE aggregation level that is different from the first CCE aggregation level, the second DCI instructing the UE to send a transmission to the network node on a second uplink resource indicated by the second DCI;
determining whether any transmission was received from the UE on the first uplink resource;
determining whether any transmission was received from the UE on the second uplink resource, and
determining, based on the determining whether any transmission was received from the UE on the first uplink resource and on the determining whether any transmission was received from the UE on the second uplink resource, which of the first and the second CCE aggregation level to use for a later PDCCH transmission.

15. Network node according to claim 14, further being operative for:
storing the result of the determination of whether any transmission was received from the UE on the first uplink resource together with the first CCE aggregation level and a quality estimate of the PDCCH;
storing the result of the determination of whether any transmission was received from the UE on the second uplink resource together with the second CCE aggregation level and the quality estimate of PDCCH, and wherein the determining which of the first and the second CCE aggregation level to use for the later PDCCH transmission is performed based on a quality estimate of the PDCCH at the later PDCCH transmission and the stored result of the determination of whether any transmission was received from the UE on the first uplink resource, the first CCE aggregation level and its stored quality estimate and the stored result of the determination of whether any transmission was received from the UE on the second uplink resource, the second CCE aggregation level and its stored quality estimate.

16. (canceled)

17. Network node according to claim 14, further being operative for, when the first DCI is a downlink assignment, the first DCI triggering a transmission of traffic data to the UE on a PDSCH, or when the first DCI is an uplink grant, the transmission that the first DCI instructs the UE to send in the first uplink resource is a transmission of traffic data from the UE to the network node, and when the second DCI is a downlink assignment, the second DCI triggering a transmission of a MAC padding PDU to the UE on the PDSCH or a retransmission of acknowledgement data on the PDSCH, or when the second DCI is an uplink grant, the transmission that the second DCI instructs the UE to send in the second uplink resource is a re-transmission of acknowledgement data.

18. Network node according to claim 14, wherein the first DCI is a downlink assignment including an indication of a downlink transmission to the UE on a first downlink resource, which downlink transmission the UE is instructed to respond to in the first uplink resource, the network node further being operative for sending, to the UE, the downlink transmission on the first downlink resource.

19. Network node according to claim 18, operative for the sending of the downlink transmission on the first downlink resource by sending a PDSCH transmission containing only a MAC padding PDU, or a PDSCH transmission containing traffic data pending in a buffer of the network node, or a PDSCH transmission indicating a re-transmission of already acknowledged or correctly received data.

20. Network node according to claim 14, wherein the second DCI is a downlink assignment including an indication of a downlink transmission to the UE on a second downlink resource, which downlink transmission the UE is instructed to respond to in the second uplink resource, the network node further being operative for sending, to the UE the downlink transmission on the second downlink resource.

21. Network node according claim 20, operative for the sending of the downlink transmission on the second downlink resource by sending a PDSCH transmission containing only a MAC padding PDU, or a PDSCH transmission containing traffic data pending in a buffer of the network node, or a PDSCH transmission indicating a re-transmission of already acknowledged or correctly received data.

22-24. (canceled)

25. Network node according to claim 14, further being operative for obtaining information on PDCCH load on a first cell in which the UE resides and/or information on PDCCH load on one or more cells that are neighbors to the first cell and the network node being operative for the determining of which of the first and the second CCE aggregation level to use for the later PDCCH transmission based also on the information on PDCCH load on the first cell and/or on the information on PDCCH load on the one or more neighboring cells.

26. Network node according to claim 14, further being operative for obtaining information on PDCCH load on a first cell in which the UE resides and/or information on PDCCH load on one or more cells that are neighbors to the first cell, and the network node being operative for triggering the transmitting of the first DCI and the second DCI in response to determining that the PDCCH load on the first cell has changed with more than a first threshold, or in response to determining that the PDCCH load on the one or more neighboring cells has changed with more than a second threshold.

27. A computer program comprising instructions, which, when executed by at least one processing circuitry of a network node of a wireless communication network, configured for handling transmission on a Physical Downlink Control Channel, PDCCH, on a Control Resource Set, CORESET, to a User Equipment, UE, causes the network node to perform the following steps:
transmitting, to the UE a first Downlink Control Information, DCI, in the PDCCH using a first Control Channel Element, CCE, aggregation level, the first DCI instructing the UE to send a transmission to the network node on a first uplink resource indicated by the first DCI;
transmitting, to the UE, a second DCI in the PDCCH using a second CCE aggregation level that is different from the first CCE aggregation level, the second DCI instructing the UE to send a transmission to the network node on a second uplink resource indicated by the second DCI;
determining whether any transmission was received from the UE on the first uplink resource;
determining whether any transmission was received from the UE on the second uplink resource, and
determining, based on the determining whether any transmission was received from the UE on the first uplink resource and on the determining whether any transmission was received from the UE on the second uplink resource, which of the first and the second CCE aggregation level to use for a later PDCCH transmission.

28. (canceled)
